(19) United States
(12) Patent Application Publication
(10) Pub. No.: US 2012/0106977 A1
(43) Pub. Date: May 3, 2012

(54) SYSTEM AND METHOD FOR COMMUNICATING USING VISIBLE LIGHT

(75) Inventors: Kyung Min MA, Goyang-si (KR); Dong Hun SEO, Suwon-si (KR)

(73) Assignee: PANTECH CO., LTD., Seoul (KR)

(21) Appl. No.: 13/197,510

(22) Filed: Aug. 3, 2011

(30) Foreign Application Priority Data
Oct. 27, 2010 (KR) 10-2010-0105082

(51) Int. Cl. H04B 10/00

(52) U.S. Cl. 398/172

(57) ABSTRACT

A server device to transmit a message through a visible light communication, in which the server includes a visible light communication unit to transceive data through visible light communication; a message reception unit to receive a message; a message identification unit to identify a receiving object, a message type, and a transmission characteristic of the message; and a message transmission unit to transmit the message to the receiving object according to the transmission characteristic of the message. A method for transmitting a message though visible light communication, in which the method includes receiving a message; identifying a receiving object of the message, a message type and a transmission characteristic of the message; and transmitting the message to the receiving object according to the transmission characteristic of the message using the visible light communication.

### CROSS-REFERENCE TO RELATED APPLICATION

This application claims priority from and the benefit under 35 U.S.C. §119(a) of Korean Patent Application No. 10-2010-0105082, filed on Oct. 27, 2010, which is incorporated by reference for all purposes as if fully set forth herein.

### BACKGROUND

1. Field

Exemplary embodiments of the present invention relate to a system and method for transmitting/receiving a message using visible light communication.

2. Discussion of the Background

As light emitting efficiency of light emitting diodes (LEDs) has become more common in the market place, such that LEDs provide lighting in fluorescent lamps, incandescent electric lamps, handheld devices, electronic displays, automobiles, traffic lights, advertising boards and the like. Also, as interest in optical wireless technology, as opposed to RF technology, has increased because of the wide array of uses of the LED technology, a lack of available frequencies in a radio frequency (RF) band, a possibility of interference of RF communication among wireless communications, an increase of security requirements for communications, the advent of a high-speed ubiquitous communication environment of fourth generation mobile communication (4G) wireless technology, and the like; studies on visible light communication technology using visible light LEDs are being conducted in many enterprises, research institutes, and the like.

The visible light communication refers to a communication technology that transmits information using a visible light. Generally, in the visible light communication technology, data may be generally transmitted by a method of modulating a visible light at a reference frequency emitted from a device with built-in LEDs, such as an illumination device or a display device. In using the visible light communication technology, it may be unnecessary to allocate frequencies, and may allow the possibility to transmit a large amount of data at a high speed by using high-speed flickering.

The visible light communication technology for transmitting information by using visible light may be advantageous in safety, a wide use band, and an ability to be freely used without being subject to regulation. Also, the visible light communication technology may be advantageous in that the reception range of information can be accurately sensed because visible light communication technology may identify a spot where light reaches or a moving direction of the light. Accordingly, the visible light communication technology may provide reliable security, and may also be advantageous in providing low electric power consumption.

### SUMMARY

Exemplary embodiments of the present invention provide a system and method for transmitting a message using visible light communication technology.

Additional features of the invention will be set forth in the description which follows, and in part will be apparent from the description, or may be learned by practice of the invention.

Exemplary embodiments of the present invention provide a server device to transmit a message through visible light communication, the server device includes a visible light communication unit to transceive data through visible light communication; a message reception unit to receive a message; a message identification unit to identify a receiving object, a message type, and a transmission characteristic of the message; and a message transmission unit to transmit the message to the receiving object according to the transmission characteristic of the message.

Exemplary embodiments of the present invention provide a method for transmitting a message through visible light communication including receiving a message; identifying a receiving object of the message; identifying a message type and a transmission characteristic of the message; and transmitting the message to the receiving object according to the transmission characteristic of the message through the visible light communication.

Exemplary embodiments of the present invention provide a system to transmit a message through visible light communication, the system includes a transmission terminal to transmit a message through the visible light communication; a server to identify information of a reception terminal comprised in the personal message, and to transmit the personal message to the reception terminal through the visible light communication; and the reception terminal to transmit a receipt message to report that the message is received by the receiving object.

Exemplary embodiments of the present invention provide a system to transmit a message through visible light communication, the system includes a transmission terminal to transmit an order registration message through the visible light communication; a window terminal to transmit a call message to call a transmission terminal having the next order; and a server to identify information of the transmission terminal included in the order registration message, to insert the information of the transmission terminal in an order list, and to transmit the call message to a transmission terminal having the next order.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram illustrating a system to transmit a message using visible light communication technology according to an exemplary embodiment of the invention.

FIG. 2 is a block diagram illustrating a server device to transmit a message using visible light communication technology according to an exemplary embodiment of the invention.

FIG. 3 is a flowchart illustrating a method for individually transmitting messages between users by using visible light communication technology in a server device according to an exemplary embodiment of the invention.

FIG. 4 is a flowchart illustrating a method for broadcasting messages to one or more receiving objects by using visible light communication technology in a server device according to an exemplary embodiment of the invention.

FIG. 5 is a flowchart illustrating a method for broadcasting a message including notification information by using visible light communication technology in a server device according to an exemplary embodiment of the invention.

FIG. 6 is a flowchart illustrating a method for registering orders of transmission terminals and calling a transmission terminal having the earliest order by using visible light communication technology in a server device according to an exemplary embodiment of the invention.

FIG. 7 is a diagram illustrating a method for transmitting messages between users by using visible light communication technology according to an exemplary embodiment of the invention.

FIG. 8 is a diagram illustrating a method for registering orders of transmission terminals and calling a transmission terminal having an earliest order by using visible light communication technology according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g., XYZ, XZ, YZ). Throughout the drawings and the detailed description, unless otherwise described, the same drawing reference numerals are understood to refer to the same elements, features, and structures. The relative size and depiction of these elements may be exaggerated for clarity, illustration, and convenience.

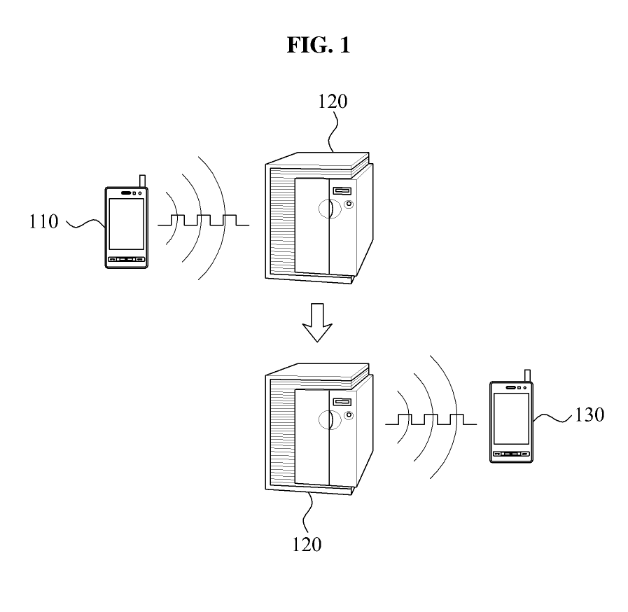

FIG. 1 is a schematic diagram illustrating a system to transmit a message using visible light communication technology according to an exemplary embodiment of the invention.

As shown in FIG. 1, a system to transmit a message using visible light communication technology includes a transmission terminal 110, a server device 120 and a reception terminal 130. In an example, the reception terminal 130 may be referred to as a receiving object.

The transmission terminal 110 may be connected to the server device 120 to transmit a message to the reception terminal 130 through visible light communication. Further, the transmission terminal 110 may connect with the server device 120 by using the visible light communication or a suitable network, such as a wireless or wired network. In an example, the transmission terminal 110 may connect with the server device by using a pairing process that may be available with the visible light communication technology.

The server device 120 may store the message transmitted by the transmission terminal 110. Then, if the server device 120 is connected to the reception terminal 130, the server device 120 may transmit the stored message to the reception terminal 130 through the visible light communication.

The system according to the exemplary embodiment of the present invention may be configured as follows.

For example, the system may be configured to transmit a message between individual terminals. In an example, the system may be configured in such a manner that a message may be transmitted between transmission terminal 110 and reception terminal 130 using the server device 120. The server device 120 may be positioned at a coffee shop, a library or a reference location. In an example, transmission terminal 110 and reception terminal 130 may refer to a personal user terminal.

Also, the system may be configured to broadcast a message to one or more terminals that may be connected to the server device 120. In an example, the system may be configured in such a manner that if the server device 120 receives a message containing notification information, the server device 120 may transmit or broadcast the message containing the notification information to one or more terminals connected thereto through the visible light communication. The server device 120 may be positioned at a populated place, such as a coffee shop, a public office or a retail store. Further, the notification information may include coupon information, sale information, store information, new product information and the like.

Also, the system may be configured in such a manner that customer orders are managed through the server device 120 at locations where people may face wait times to receive their orders, such as a bank, a ticketing office, a restaurant, and the like. In an example, the server device 120 may register identifying information of the transmission terminal 110 to an order list, which manages registered transmission terminals and specifies which transmission terminal is to be serviced next. The particular order of service may be based on registration time, type of service requested, type of customer, and other criteria. The server device 120 may subsequently receive a call message indicating that the transmission terminal 110 is to be serviced next. The call message may then be transmitted from the server device 120 to the transmission terminal 110 to notify the terminal that it is ready to be serviced next in the order list.

Further, the server device 120 may include multiple servers connected in a wired and/or wireless network, such as the internet or an intranet network, to transmit a message from the transmission terminal 110 to the reception terminal 130 at a same location or different locations.

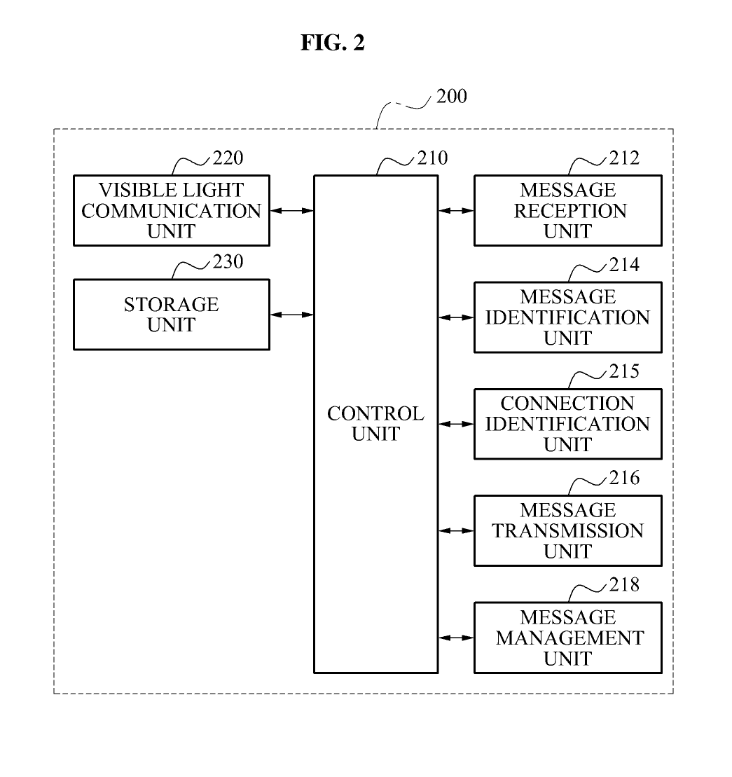

FIG. 2 is a block diagram illustrating a server device to transmit a message using visible light communication technology according to an exemplary embodiment of the invention.

As shown FIG. 2, the server device 200 includes a control unit 210, a message reception unit 212, a message identification unit 214, a connection identification unit 215, a message transmission unit 216, a message management unit 218, a visible light communication unit 220, and a storage unit 230.

The visible light communication unit 220 connects to a transmission terminal 110 or a reception terminal 130 through a visible light communication or by other suitable network technologies. Once connected, the visible light communication unit 220 transmits and/or receives (“transceive”) data with the connected terminals using the visible light communication. In an example, transceiving data may include only transmitting data, only receiving data, or both transmitting and receiving data. If the visible light communication unit 220 transmits data, the visible light communication unit 220 may modulate the data to a visible light pulse and transmits the modulated pulse. If the visible light communication unit 220 receives data, the visible light communication unit 220 receives a visible light pulse and demodulates the received light pulse to retrieve the data.

The storage unit 230 stores an operating system, which may control the entire operation of the server device 200, application programs, and related and additional data. The storage unit 230 may also store a message received from a transmission terminal 110. In a case where the server device 200 provides an order management service, the storage unit 230 may store an order list that specifies order of transmission to one or more transmission terminals that register their orders.

The message reception unit 212 may receive a message from a transmission terminal 110 using the visible light communication and store the received message in the storage unit 230. In this instance, the message may contain identification information of the transmission terminal 110, identification information of a receiving object, a message type, an error detection code and a content of the message. The content of the message may be encoded so as to be identified in the receiving object. In an example, the receiving object may be a receiving terminal of the transmitted message.

The message type may include, without limitation, a personal memo, a notification message, a group message, an order registration message, and a call message. The personal memo may be a message intended to be transmitted between individual terminals. The notification message may be used to broadcast notification contents using the visible light communication to one or more terminals connected to the server device 200. The group message may be a message that is transmitted to one or more terminals that belong to the group specified in the message and connected to the server device 200. Accordingly, if a group message is intended to be transmitted to all of the terminals in group A, the group A terminals connected to the server device 200 may be the receiving objects for the respective group message. The order registration message may be used to register a customer order at locations where the user may face wait times (e.g., a bank or cinema). In an example, if the user is faced with a long wait time, the user may register the user's respective terminal to be placed in the order list. Once the user is determined to be the next person to be served, a call message may be used to call the respective user terminal to notify the user.

The message identification unit 214 analyzes the received message to identify a receiving object of the message, the message type, and a transmission characteristic based on the message type.

In an example, the transmission characteristic may specify the timing and the frequency of the message transmission. In an example, the transmission characteristic may include at least one of a reference transmission interval, a reference transmission time or duration, a reference transmission interval for a reference time or duration, and a condition for transmission. In an example, the condition for transmission may specify to transmit the message after identifying connection availability or type of the receiving object.

Further, the transmission characteristic may be based on the identified message type. For example, if the message type is determined to be a personal memo, the transmission characteristic may specify the message to be sent upon identifying the receiving object, as well as to specify transmission duration of 1 minute for every other minute for a total of 5 minutes or until a response indicating a receipt of the transmitted message is received by the transmitting terminal 110. If the message type is determined to be a notification message advertising a sale at a clothing store, the transmission characteristic may specify the message to be sent one week prior to the sale and each day after until a response indicating a receipt of the transmitted message is received by the transmitting terminal 110. However, the transmission characteristic may also specify to transmit the message for a specified duration or frequency even after the receipt response is received.

The receiving object may be one of the terminals connected to the visible light communication unit 220 using the visible light communication, a terminal belonging to a specific group and connected to the visible light communication unit 220 using the visible light communication, or an individual terminal connected to the visible light communication unit 220 using the visible light communication.

The connection identification unit 215 determines whether the receiving object of the identified message is connected to the visible light communication unit 220 using the visible light communication.

The message transmission unit 216 transmits the message to the receiving object according to the identified transmission characteristic of the message.

In an example, if the message type is determined to be a personal memo, the transmission characteristic of the personal memo may specify an individual transmission message to be transmitted upon identification of the receiving object. The connection identification unit 215 identifies the connection of the visible light communication unit 220 to the receiving object. Then, the message transmission unit 216 individually transmits the message to the receiving object. If the message reception unit 212 receives a message in response from the receiving object reporting that the message has been received, the message transmission unit 216 deletes the message stored in the storage unit 230. Although it is not illustrated, the stored message may also be stored in the storage unit 230 for an indefinite duration or deleted as a batch at reference intervals.

In another example, if the message type is determined to be a notification message, the transmission characteristic may specify broadcasting the message at reference intervals and/or duration until the occurrence of a condition or receiving of a response message from the receiving object indicating the receipt of the message. The message transmission unit 216 broadcasts the message at the specified time intervals and/or duration. If the message reception unit 212 receives a response message for reporting that the message has been received from the receiving object, the broadcasting of the message may be stopped, and the message transmission unit 216 may delete the message stored in the storage unit 230. Further, the transmission characteristic of the notification message may also specify the message transmission unit 216 to broadcast the message for a reference number of tries until the message reception unit 212 receives the response message.

In an example where the message type is determined to be a notification message, the transmission characteristic of the notification message may specify broadcasting the notification message based on a condition. More specifically, the transmission characteristic may specify the message transmission unit 216 to transmit the message to one or more terminals that are determined to be connected to the visible light communication unit 220 using the visible light communication.

In an example where the message type is determined to be a group message, the transmission characteristic of the notification message may specify to transmit the message based on a condition that the receiving object belongs to a specific group, the message transmission unit 216 transmits the message to one or more terminals belonging to that group that are connected to the visible light communication unit 220 using the visible light communication technology. In an example, if a notification message is to be sent to group A, one or more terminals belonging to group A may receive the message transmitted by the message transmission unit 216.

If the message type is determined to be an order registration method, the message management unit 218 may insert identifying information of the transmission terminal 110, which may be contained in the message, in the order list to reserve a spot in the order list. Then, if the transmission terminal 110 is the next terminal to be served, the message reception unit 212 may receive a call message from a window terminal that manages orders. After receiving the called message, the message transmission unit 216 transmits the call message to the transmission terminal 110, which may have the highest priority among terminals included in the order list or the next terminal to be served.

The control unit 210 may control the entire operation of the server device 200. The control unit 210 may perform processes of the message reception unit 212, the message identification unit 214, the connection identification unit 215, the message transmission unit 216 and the message management unit 218. The enumerated components are illustrated separately to individually describe their processes for convenience of description. Thus, the control unit 210 may include at least one processor configured to perform portions of, or one or more of, the processes of the message reception unit 212, the message identification unit 214, the connection identification unit 215, the message transmission unit 216 and the message management unit 218.

Hereinafter, a method for transmitting a message using the visible light communication will be described with reference to the following drawings.

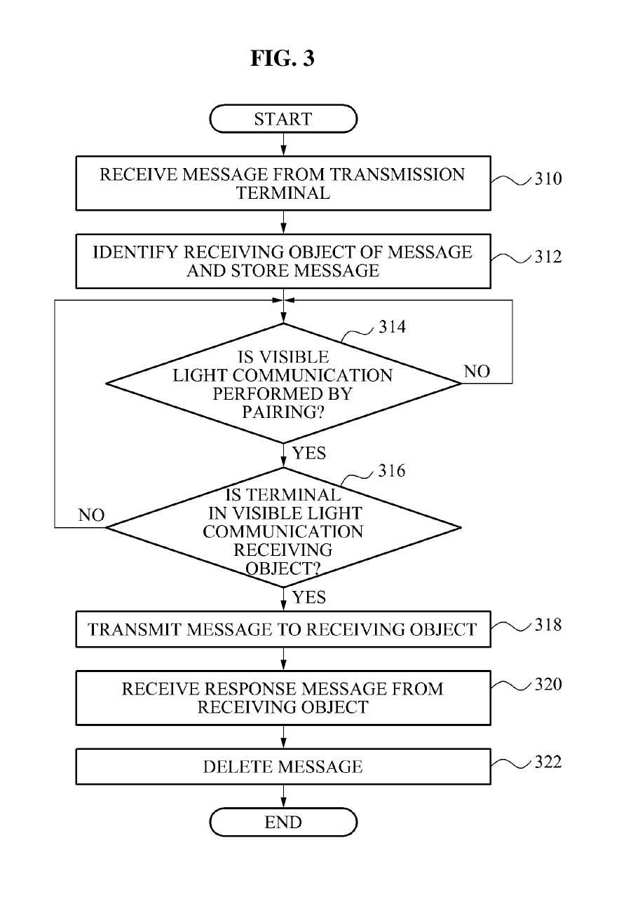

FIG. 3 is a flowchart illustrating a method for individually transmitting messages between users by using the visible light communication technology in a server device according to an exemplary embodiment of the invention.

Referring to FIG. 3, in operation 310, the server device 200 receives a message from a transmission terminal 110 using a visible light communication. In operation 312, the server device 200 identifies a receiving object of the message and stores the message. In an example, the receiving object may refer to a receiving terminal 130 that may be connected to the visible light communication unit 220.

In operation 314, the server device 200 determines whether a connection by pairing between the server device 200 and one or more terminals using the visible light communication is present. Connection by pairing may be established by transmitting and receiving visible light communication between transmitting terminals and/or the server device 200. In addition, although not illustrated, the server device 200 may also determine the existence of a network connection between the server device 200 and one or more terminals. For example, the terminals using the visible light communication technology may be connected with the server device 200 by using a suitable wired or wireless connection.

If the connection by pairing between the server device 200 and one or more terminals is determined to be available in operation 314, the server device 200 determines whether a terminal connected to the visible light communication unit 220 is a receiving object. If the terminal is determined not to be the receiving object of the message in operation 316, the server device 200 returns to operation 314.

If the terminal is determined to be the receiving object of the message in operation 316, the server device 200 transmits the stored message to the receiving object in operation 318. In an example, the stored message may be originally received from the transmission terminal 110.

If the server device 200 receives a response message reporting receipt of the transmitted message from the receiving object in operation 320, server device 200 deletes the stored message in operation 322.

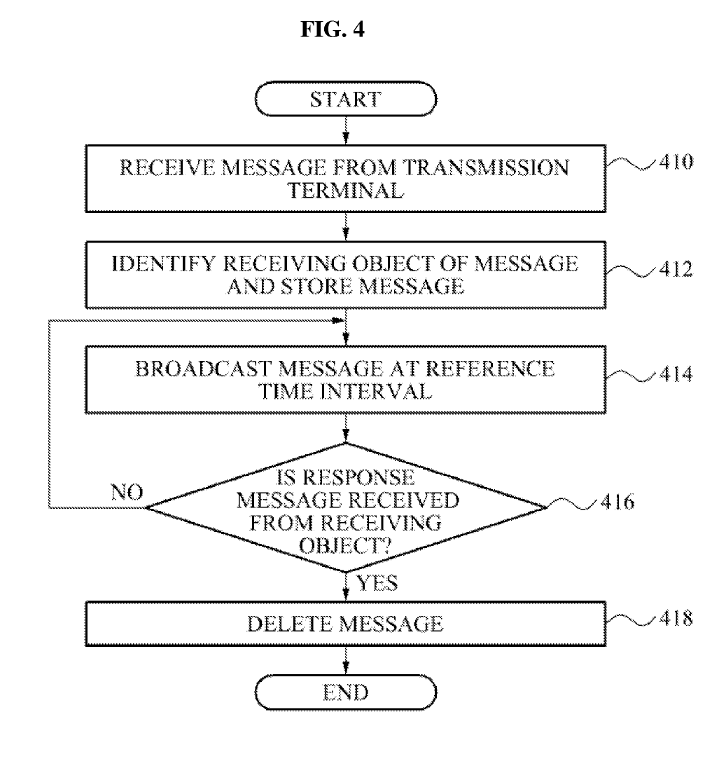

FIG. 4 is a flowchart illustrating a method for broadcasting messages to one or more receiving objects by using visible light communication technology in a server device according to an exemplary embodiment of the invention.

Referring to FIG. 4, in operation 410, the server device 200 receives a message from a transmission terminal 110 using a visible light communication. In operation 412, the server device 200 identifies a receiving object of the message and stores the received message.

In operation 414, the server device 200 broadcasts the message to the receiving object at a reference interval.

In operation 416, the server device 200 determines whether a response message has been transmitted from the receiving object indicating receipt of the broadcasted message. In this instance, the response message may be a message reporting that the receiving object has successfully received the message transmitted from the server device 200. If the response message is not received from the receiving object in operation 416, the server device 200 returns to operation 414.

If the response message is received from the receiving object in operation 416, the server device 200 deletes the stored message in operation 418.

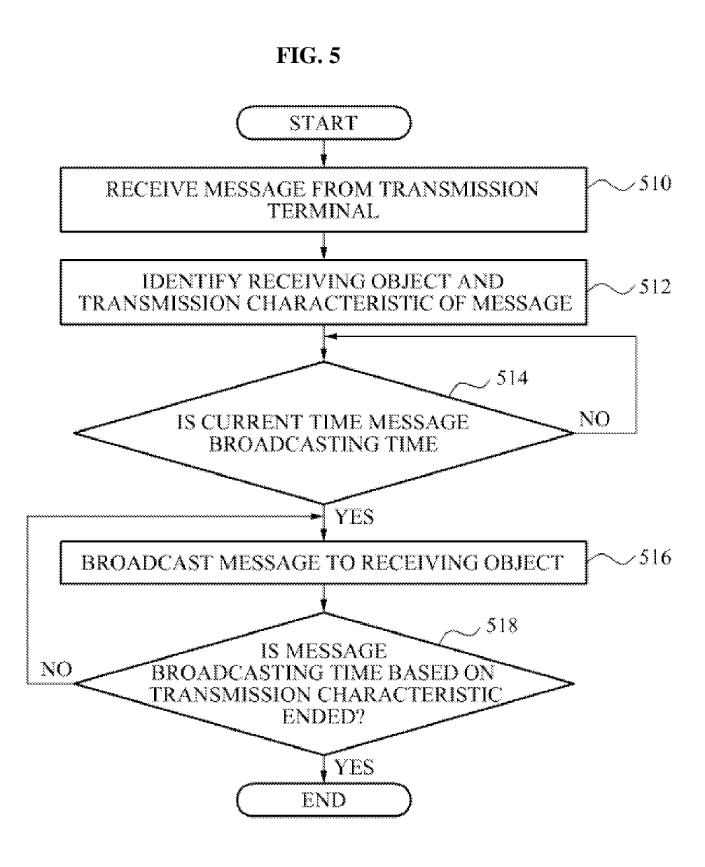

FIG. 5 is a flowchart illustrating a method for broadcasting a message including notification information by using the visible light communication in a server device according to an exemplary embodiment of the invention.

Referring to FIG. 5, in operation 510, the server device 200 receives a message from a transmission terminal 110 using a visible light communication stores the received message (not pictured). In this instance, the transmission terminal 110 may be a managing terminal, and the message may be a notification message containing notification information.

In operation 512, the server device 200 identifies a recipient or a receiving object to receive the stored message. In addition, the server device 200 also determines a message type of the stored message, and identifies a transmission characteristic based on the determined message type. In an example, the transmission characteristic may specify the timing and the frequency of the message transmission. Further, the transmission characteristic may also include at least one of a reference transmission interval, a reference transmission time or duration, a reference transmission interval for a reference time or duration, and a reference transmission time or duration at a reference interval.

In operation 514, the server device 200 determines whether the current time corresponds to a message broadcasting time according on the transmission characteristic. For example, if the transmission characteristic has a transmission time of 2:00 PM, the server device 200 may check to determine whether the current time corresponds to the respective transmission time.

In operation 514, if the current time is determined to be the message broadcasting time corresponding to the transmission characteristic, the server device 200 broadcasts the stored message to the receiving object in operation 516.

In operation 518, the server device 200 determines whether the message broadcasting time based on the transmission characteristic has ended. If the message broadcasting time has not ended in operation 518, the server device 200 returns to operation 516. If the message broadcasting time has ended in operation 518, the server device 200 terminates this algorithm.

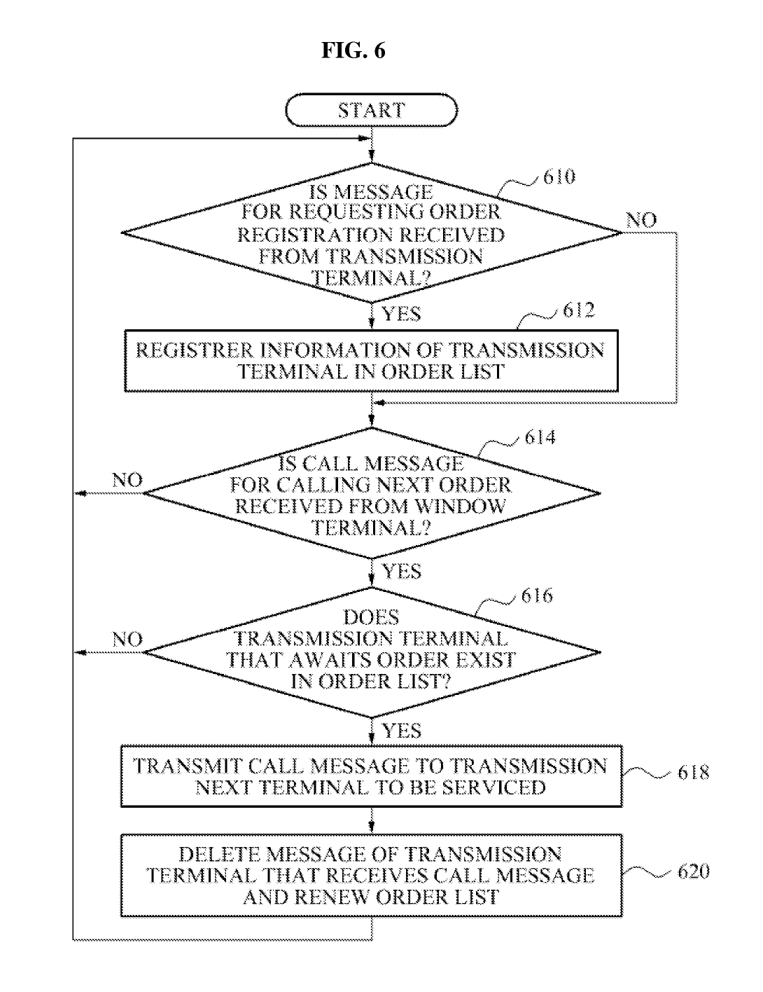

FIG. 6 is a flowchart illustrating a method for registering orders of transmission terminals and calling a transmission terminal having the earliest order by using visible light communication technology in a server device according to an exemplary embodiment of the present invention.

Referring to FIG. 6, if the server device 200 receives a request for an order registration message from a transmission terminal 110 in operation 610, the server device 200 identifies transmission terminal information contained in the message and registers the identified transmission terminal information in an order list in operation 612.

In operation 614, the server device 200 checks to determine whether a call message for calling the next order has been transmitted from a window terminal. In an example, the call message is a message that indicates that the user of the transmission terminal 110 is next in the order list to be serviced, and the window terminal may refer to an entity (e.g., bank teller, department of motor vehicle teller, etc.) providing service to the user of the transmission terminal 110.

If the call message is not received in operation 614, the server device 200 returns to operation 610. If the call message is received in operation 614, the server device 200 checks to determine whether the respective transmission terminal information exists in the order list in operation 616.

If the order list is empty in operation 616, the server device 200 returns to operation 610. If the transmission terminal information exists in the order list in operation 616, the server device 200 transmits the call message to the transmission terminal corresponding to the transmission terminal information, which may be the next terminal to be serviced or have the earliest order in the current order list in operation 618.

In operation 620, the server device 200 deletes the stored message of the transmission terminal 110 that received the call message and renews or updates the order list. Then, the server device 200 returns to operation 610 and continuously performs operation 620.

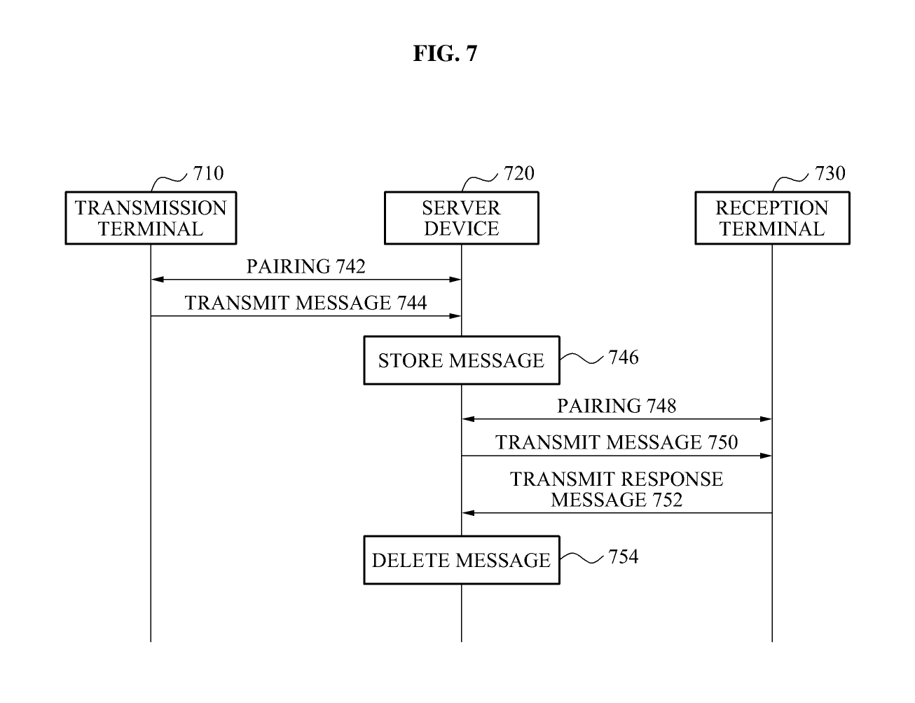

FIG. 7 is a diagram illustrating a method for transmitting messages between users by using visible light communication technology according to an exemplary embodiment of the invention.

Referring to FIG. 7, in operation 742, a transmission terminal 710 is connected by pairing to the server device 720 using the visible light communication. In operation 744, the transmission terminal 710 generates a message and transmits the message to the server device 720. In an example, the message may be a personal memo.

If the server device 720 receives the message, the server device 720 identifies a receiving object for the message, a message type, and a transmission characteristic based on the type of the message. The server device 720 then stores the message in operation 746.

Then, the server device 720 connects by pairing to a reception terminal 730 and determines that the reception terminal 730 is the receiving object of the message using the visible light communication in operation 748. The server device 720 then transmits the stored message to the reception terminal 730 in operation 750.

If the reception terminal 730 receives the transmitted message in operation 750, the reception terminal 730 transmits, to the server device 720, a response message to report that is the message is received in operation 752.

If the server device 720 receives the response message in operation 752, the server device 720 deletes the stored message corresponding to the response message in operation 754. Although it is not illustrated, the stored message may also be stored in the server device 720 for an indefinite duration or deleted as a batch at reference intervals.

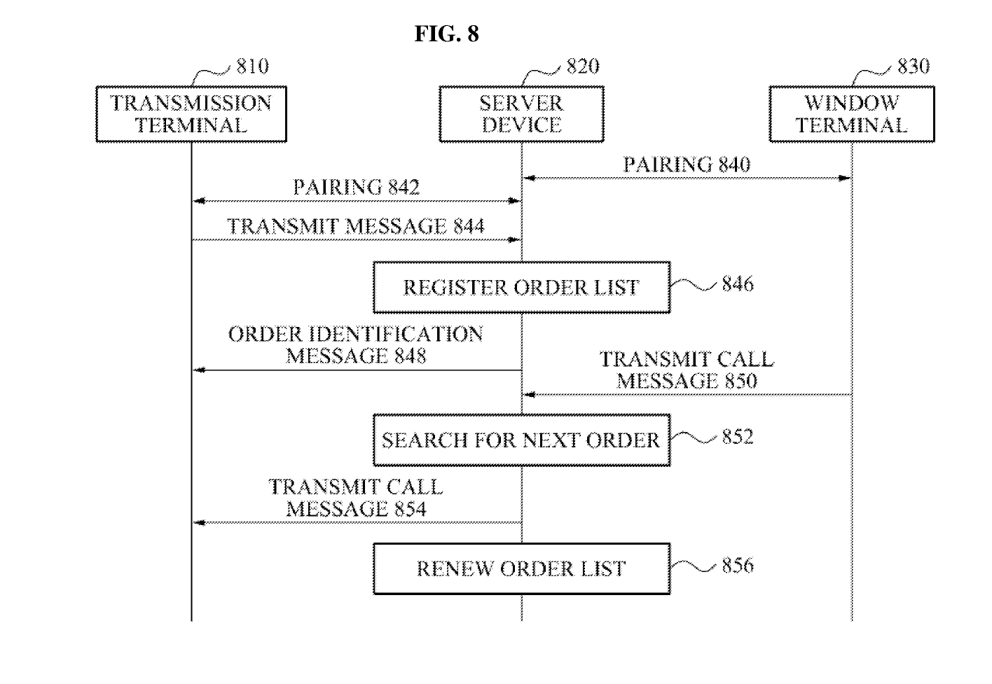

FIG. 8 is a diagram illustrating a method for registering orders of transmission terminals and calling a transmission terminal having an earliest order by using visible light communication in the system technology according to an exemplary embodiment of the invention.

Referring to FIG. 8, in operation 840, a window terminal 830 connects to a server device 820 by pairing using a visible light communication. In an example, the connection between the window terminal 830 and the server device 820 may not limited to the connection established by the visible light communication. That is, the window terminal 830 and the server device 820 may be connected using other suitable networking technology, such as wired or wireless communication.

Then, in operation 842, a transmission terminal 810 connects to the server device 820 by pairing using the visible light communication. In operation 844, the transmission terminal 810 generates an order registration message for requesting order registration for the transmission terminal 810 and transmits the order registration message to the server device 820. In an example, the order registration message may include the identifying information of the transmission terminal 810.

If the server device 820 receives the order registration message in operation 844, the server device 820 identifies the transmission terminal 810 information contained in the order registration message, and registers the transmission terminal 810 information in an order list in operation 846. In operation 848, the server device 820 generates an order identification message containing the order information of the transmission terminal 810 and transmits the order identification message to the transmission terminal 810.

Then, if the server device 820 receives a call message for the next order from the window terminal 830 in operation 850, the server device 820 searches for a transmission terminal 810 having the order registered to be serviced next or the earliest order among transmission terminals included in the current order list in operation 852.

In operation 854, the server device 820 transmits the call message to the transmission terminal 810 having the earliest order. Then, the server device 820 deletes information of the transmission terminal 810 that has received the call message in the order list and renews or updates the order list in operation 856. Although described herein as window terminal 830, aspects need not be limited thereto such that the window terminal 830 may be a mobile terminal.

According to exemplary embodiments of the invention, there is provided a system including a server device to store a message transmitted from a transmission terminal using visible light communication technology, identifying a receiving object of the message, a message type, a transmission characteristic based on the type of the message, and a condition for transmitting the message. Thus, various transmission methods are provided using visible light communication technology applicable to various places.

The exemplary embodiments according aspects to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A server device to transmit a message through visible light communication, the server device comprising:
a visible light communication unit to transceive data through the visible light communication;
a message reception unit to receive a message;
a message identification unit to identify a receiving object, a message type, and a transmission characteristic of the message, wherein the transmission characteristic is based on the message type; and
a message transmission unit to transmit the message to the receiving object according to the transmission characteristic of the message.

2. The server device of claim 1, wherein the transmission characteristic comprises at least one of a transmission interval, a transmission frequency, a transmission time or duration, a transmission interval for a transmission time or duration, and a condition for transmission.

3. The server device of claim 2, wherein the condition for transmission comprises determining an existence of a connection between the receiving object and the server device as the condition.

4. The server device of claim 1, wherein the receiving object is a terminal connected to the visible light communication unit through the visible light communication, a terminal belonging to a target group among a plurality of terminals connected to the visible light communication unit through the visible light communication, or a target terminal specified to receive the message and connected to the visible light communication unit through the visible light communication.

5. The server device of claim 1, wherein the message comprises identification information of a terminal, identification information of a receiving object, a message type, an error detection code, and a message content.

6. The server device of claim 5, wherein the message type comprises at least one of:
a personal memo to transmit the message to the receiving object, wherein the receiving object is a target terminal specified to receive the message;
a notification message to transmit a notification content to the receiving object, wherein the receiving object is either a terminal that is connected to the server device through the visible light communication or a terminal belonging to a target group among a plurality of terminals connected to the server device through the visible light communication;
an order registration message to register a terminal to an order list, wherein the order list manages registered terminals and specifies which terminal in the order list is to be serviced next; and
a call message to call the registered terminal to be serviced next in the order list.

7. The server device of claim 1, further comprising a connection identification unit to determine whether the visible light communication unit is connected to the receiving object,
wherein if the message type of the message is a personal memo and the connection identification unit determines that the visible light communication unit is connected to the receiving object, the message transmission unit transmits the message to the receiving object through the visible light communication.

8. The server device of claim 7, wherein if the message transmission unit receives a receipt message to report that the message has been received by the receiving object, the message transmission unit deletes the message.

9. The server device of claim 1, wherein the message transmission unit stops transmitting the message if the message transmission unit receives a receipt message to report that the message has been received by the receiving object.

10. The server device of claim 9, wherein the message transmission unit transmits the message for a reference number of times or until the message reception unit receives the receipt message.

11. The server device of claim 1, wherein if the message type is a notification message, the message transmission unit transmits the message according to the transmission characteristic to the receiving object.

12. The server device of claim 1, wherein if the message type is a group message, the group message specifying a target group, the message transmission unit transmits the message to the receiving object, wherein the receiving object is a terminal belonging to the target group and connected to the visible light communication unit.

13. The server device of claim 1, further comprising a message management unit to insert identifying information of a terminal into the message to be transmitted to an order list if the message type is an order registration message, wherein the order list manages registered terminals and specifies which terminal in the order list is to be serviced next.

14. The server device of claim 13, wherein if the message transmission unit receives a call message indicating that the terminal is to be serviced next, and the message transmission unit transmits the call message to the terminal to be serviced next.

15. A method for transmitting a message using visible light communication, the method comprising:
receiving a message;
identifying a receiving object of the message, a message type and a transmission characteristic of the message, wherein the transmission characteristic is based on the message type; and
transmitting the message to the receiving object according to the transmission characteristic of the message through the visible light communication.

16. The method of claim 15, wherein the receiving object is a terminal connected to a visible light communication server device through the visible light communication, a terminal belonging to a target group among a plurality of terminals connected to the visible light communication server device through the visible light communication, or a target terminal specified to receive the message and connected to the visible light communication server device through the visible light communication.

17. The method of claim 15, wherein the message comprises identification information of a terminal providing the message to the server device, identification information of a receiving object, a message type, an error detection code, and a message content.

18. The method of claim 15, wherein the message type comprises at least one of:
a personal memo to transmit the message to the receiving object, wherein the receiving object is a target terminal specified to receive the message;
a notification message to transmit notification content to the receiving object, wherein the receiving object is either a terminal connected to the visible light communication server device through the visible light communication or a terminal belonging to a target group among a plurality of terminals connected to the server device through the visible light communication;
an order registration message to register a terminal to an order list, wherein the order list manages registered terminals and specifies which terminal in the order list is to be serviced next; and
a call message to call the registered terminal to be serviced next in the order list.

19. The method of claim 15, wherein if the message type is determined to be a personal memo, the message is transmitted to the receiving object through the visible light communication, the receiving object being a target terminal specified to receive the message.

20. The method of claim 15, wherein the message is transmitted to the receiving object at a reference time interval if the message type is a personal memo.

21. The method of claim 20, further comprising receiving a receipt message and terminating the transmission of the message, wherein the receipt message reports that the message has been received by the receiving object.

22. The method of claim 15, wherein if the message type is a notification message, the notification message is transmitted to the receiving object according to the transmission characteristic to the receiving object.

23. The method of claim 15, further comprising:
registering the terminal in an order list based on identifying information of the terminal received in the message, wherein the order list manages registered terminals and specifies which terminal is to be serviced next;
receiving a call message identifying the terminal to be serviced next; and
transmitting the call message to the terminal to be serviced next.

24. A system to transmit a message through visible light communication, the system comprising:
a transmission terminal to transmit a message through the visible light communication;
a server device to identify information of a reception terminal from the message, and to transmit the message to the reception terminal through the visible light communication; and
the reception terminal to transmit a receipt message to report that the message is received by the receiving object.

25. A system to transmit a message through visible light communication, the system comprising:
a transmission terminal to transmit an order registration message through the visible light communication;
a window terminal to transmit a call message to call the transmission terminal, wherein the transmission terminal is to be serviced next; and
a server device to identify information of the transmission terminal from the order registration message, to insert the information of the transmission terminal in an order list, and to transmit the call message to the transmission terminal to be serviced next.
